(19) United States
(12) Patent Application Publication
(10) Pub. No.: US 2024/0384052 A1
(43) Pub. Date: Nov. 21, 2024

(54) FORMULATION FOR THE PRODUCTION OF POROUS POLYMER PARTICLES

(71) Applicant: ASTREA UK SERVICES LIMITED, Cambridge (GB)

(72) Inventor: Nadia LALANCETTE, Quebec (CA)

(21) Appl. No.: 18/692,532

(22) PCT Filed: Sep. 16, 2022
(86) PCT No.: PCT/GB2022/052347

§ 371 Date: Mar. 15, 2024

(30) Foreign Application Priority Data
Sep. 17, 2021 (GB) 2113284.0

(51) Int. Cl. C08J 9/00; C08J 9/30

(52) U.S. Cl. CPC C08J 9/0066; C08J 9/30; C08J 2305/00

(57) ABSTRACT

The disclosure provides a formulation for the production of porous polymer particles. The formulation comprises a polymer; a salt; and at least one buffer. The salt is an antichaotropic salt and the at least one buffer is present at a weight ratio of the at least one buffer to the polymer of at least 1:40.

The present disclosure relates to a formulation which may be used to produce porous polymer particles. In particular, the disclosure relates to a formulation which may be used to produce porous polymer beads, using a spinning disc, in a continuous or semi-continuous process. The disclosure extends to a method of producing the formulation, a use thereof and a method of producing porous polymer particles.

The capacity of certain porous support particles to cause selective retardation based on either size or shape is well known. Such particles are used in chromatographic separation techniques, for example gel filtration, to separate biological macromolecules, e.g. proteins, DNA, RNA polysaccharides and the like. The sieving particles are characterized by the presence of a microporous structure that exerts a selective action on the migrating solute macromolecules, restricting passage of larger particles more than that of the smaller particles. Thus, the utility of sieving lies in the capacity of the particles to distinguish between molecules of different sizes and shapes.

Affinity chromatography is a chromatographic method used for the isolation of proteins and other biological compounds. This technique is performed using an affinity ligand attached to a support particle and the resulting adsorbent packed into a chromatography column. The target protein is captured from solution by selective binding to the immobilized ligand. The bound protein may be washed to remove unwanted contaminants and subsequently eluted in a highly purified form.

Good separation using chromatography techniques depends on the size of particles, the size distribution of particles and the porosity of the particles. The beads, once packed into a column, should be of a high strength in order to support the liquid flow rates observed during purification and column regeneration. To ensure that any polymer beads produced are suitable, batches may be tested to check that they exhibit a desired flow rate and/or that the beads have a desired porosity.

It has been found that the formulations used to produce the polymer beads can be subject to physical changes over time. This means that beads produced later in a run can have a lower flow rate and/or a higher porosity, and may not be suitable for use in chromatography. To overcome this problem, it has been necessary to only run small batches when producing the polymer beads. This allows the entire formulation to be processed before degradation has too great an effect. However, if possible, it would be desirable to be able to process larger batch sizes as this would allow for greater efficiency.

The present invention comes from the inventors' work in attempting to overcome the problems associated with the prior art.

In accordance with a first aspect of the disclosure, there is provided a formulation for the production of porous polymer particles, the formulation comprising a polymer; a salt; and at least one buffer; wherein the salt is an antichaotropic salt and the at least one buffer is present at a weight ratio of the at least one buffer to the polymer of at least 1:40.

Advantageously, the inventors have found that the at least one buffer is able to stabilize the formulation. This means that large batches of the formulation of the first aspect can be used to produce polymer beads with the required specification to allow then to be used in chromatography techniques. This enables these polymers beads to be produced more efficiently. This would not be possible using a prior art formulation.

It may be appreciated that any weight ratios, unless stated otherwise, relate to the weight ratio of the pure components. Accordingly, unless stated otherwise, the weight ratio does not relate to the weight of the solvent component of the solutions containing the components. Furthermore, the weight ratios do not incorporate the weight of any solvate molecules. For instance, the weight ratio of the at least one buffer to the polymer may be understood to be the weight of the pure buffer compared to the weight of the pure polymer, and does not include the weight of any solvents which may be present in the formulation.

In some embodiments, the formulation comprises a solvent. The solvent may comprise or consist of water.

The formulation may have a pH between 2.5 and 12 at 20° C., more preferably between 3 and 10, between 3.5 and 8 or between 4 and 6 at 20° C., and most preferably between 4.5 and 5.5 at 20° C. The at least one buffer may be selected and provided at an appropriate concentration to maintain the formulation at this pH.

The at least one buffer may comprise or be a phosphate buffer, a sulphate buffer, a citrate buffer, an acetate buffer, a tris(hydroxymethyl)aminomethane (tris) buffer and/or a 2-(N-morpholino)ethanesulfonic acid (MES) buffer. Preferably, the at least one buffer comprises or is a phosphate buffer and/or a sulphate buffer. Most preferably, the at least one buffer comprises or is a phosphate buffer.

The at least one buffer may comprise a cation and an anion. The anion may comprise dihydrogen phosphate, hydrogen phosphate, phosphate, pyrophosphate, sulphate or hydrogen sulphate. Preferably, the buffer comprises dihydrogen phosphate, hydrogen phosphate, phosphate or a combination thereof. The cation may be an alkali metal ion, an alkaline earth metal ion, a transition metal ion or +NR₄, where each R is independently hydrogen, an alkyl, an alkenyl or an alkynyl. The alkyl may be a C₁₋₆ alkyl, the alkenyl may be a C₂₋₆ alkenyl and the alkynyl may be a C₂₋₆ alkynyl. Accordingly, the cation may a lithium ion, a sodium ion, a potassium ion, a beryllium ion, a magnesium ion, a calcium ion, an ammonium ion or a trimethyl ammonium. Accordingly, the at least one buffer may comprise lithium dihydrogen phosphate, sodium dihydrogen phosphate, potassium dihydrogen phosphate, beryllium dihydrogen phosphate, magnesium dihydrogen phosphate, calcium dihydrogen phosphate, ammonium dihydrogen phosphate, dilithium hydrogen phosphate, disodium hydrogen phosphate, dipotassium hydrogen phosphate, beryllium hydrogen phosphate, magnesium hydrogen phosphate, ammonium hydrogen phosphate, lithium phosphate, sodium phosphate, potassium phosphate, beryllium phosphate or ammonium phosphate.

In some embodiments, the at least one buffer comprises or is a combination of a dihydrogen phosphate buffer and a hydrogen phosphate buffer. Most preferably, the at least one buffer comprises or consists of sodium dihydrogen phosphate and sodium hydrogen phosphate.

The weight ratio of the dihydrogen phosphate to the hydrogen phosphate may be at least 10:1, at least 20:1, at least 30:1, at least 35:1, at least 40:1 or at least 45:1. The weight ratio of the dihydrogen phosphate to the hydrogen phosphate may be less than 100:1, less than 80:1, less than 70:1, less than 60:1, less than 55:1 or less than 50:1. The weight ratio of the dihydrogen phosphate to the hydrogen phosphate may be between 10:1 and 100:1, between 20:1 and 80:1, between 30:1 and 70:1, between 35:1 and 60:1, between 40:1 and 55:1 or between 45:1 and 50:1.

The molar ratio of the dihydrogen phosphate to the hydrogen phosphate may be at least 10:1, at least 20:1, at least 30:1, at least 40:1, at least 50:1 or at least 55:1. The weight ratio of the dihydrogen phosphate to the hydrogen phosphate may be less than 200:1, less than 150:1, less than 100:1, less than 80:1, less than 65:1 or less than 60:1. The weight ratio of the dihydrogen phosphate to the hydrogen phosphate may be between 10:1 and 200:1, between 20:1 and 150:1, between 30:1 and 100:1, between 40:1 and 80:1, between 50:1 and 65:1 or between 55:1 and 60:1.

The weight ratio of the at least one buffer to the polymer may be less than 1:2, less than 1:3, less than 1:4, less than 1:5, less than 1:6, less than 1:6.5 or less than 1:7. The weight ratio of the at least one buffer to the polymer may be at least 1:30, at least 1:20, at least 1:15, at least 1:10, at least 1:8 or at least 1:7.5. The weight ratio of the at least one buffer to the polymer may be between 1:2 and 1:40, between 1:3 and 1:30 or between 1:4 and 1:20. The weight ratio of the at least one buffer to the polymer may be between 1:4 and 1:10, between 1:4 and 1:8, between 1:4 and 1:6 or between 1:4 and 1:5. The weight ratio of the at least one buffer to the polymer may be between 1:5 and 1:15 or between 1:6 and 1:10. In one embodiment, the weight ratio of the at least one buffer to the polymer may be between 1:6 and 1:8 or between 1:6 and 1:7. In a preferred embodiment, the weight ratio of the at least one buffer to the polymer may be between 1:6.5 and 1:8 or between 1:7 and 1:7.5. It may be appreciated that in embodiments where the at least one buffer comprises two or more different compounds, the weight ratio is calculated using the combined weight of the two or more different compounds.

In embodiments where the formulation comprises a solvent, the at least one buffer may be present in an amount which is at least 3 g/L, at least 4 g/L, at least 5 g/L, at least 6 g/L, at least 7 g/L, at least 8 g/L, at least 9 g/L or at least 10 g/L. The at least one buffer may be present in an amount which is less than 50 g/L, less than 45 g/L, less than 40 g/L, less than 35 g/L, less than 30 g/L, less than 25 g/L, less than 20 g/L, less than 15 g/L, less than 12.5 g/L or less than 11 g/L. The at least one buffer may be present in an amount which is between 3 and 50 g/L, between 4 and 40 g/L, between 5 and 30 g/L, between 6 and 25 g/L or between 7 and 20 g/L. The at least one buffer may be present in an amount which is between 7 and 15 g/L, between 7 and 10 g/L, between 7.5 and 9 g/L or between 7.5 and 8.5 g/L. The at least one buffer may be present in an amount which is between 8 and 15 g/L, between 9 and 12.5 g/L, between 10 and 11 g/L or between 10 and 12 g/L. It may be appreciated that in embodiments where the at least one buffer comprises two or more different compounds, the concentration is calculated using the combined weight of the two or more different compounds.

In embodiments where the formulation comprises a solvent, the at least one buffer may be present in an amount which is at least 0.001 M, at least 0.0025 M, at least 0.005 M, at least 0.01 M, at least 0.025 M, at least 0.05 M, at least 0.07 M or at least 0.08 M. The at least one buffer may be present in an amount which is less than 2 M, less than 1 M, less than 0.5 M, less than 0.3 M, less than 0.2 M, less than 0.15 M, less than 0.1 M or less than 0.09 M. The at least one buffer may be present in an amount which is between 0.001 and 2 M, between 0.0025 and 1 M, between 0.005 and 0.5 M, between 0.01 and 0.3 M, between 0.025 and 0.2 M, between 0.05 and 0.15 M, between 0.07 and 0.1 M or between 0.08 and 0.09 M. It may be appreciated that in embodiments where the at least one buffer comprises two or more different compounds, the concentration is calculated using the combined moles of the two or more different compounds.

It may be appreciated that in embodiments where the at least one buffer is provided as a solvate, the weight of the solvate molecule is not included when reciting weight ratios or concentrations.

The polymer may be a polysaccharide. The polysaccharide may be agarose.

In embodiments where the formulation comprises a solvent, the polymer may be present in an amount which is at least 10 g/L, at least 20 g/L, at least 30 g/L, at least 40 g/L, at least 50 g/L, at least 60 g/L, at least 70 g/L or at least 75 g/L. The polymer may be present in an amount which is less than 200 g/L, less than 175 g/L, less than 150 g/L, less than 125 g/L, less than 100 g/L, less than 90 g/L, less than 80 g/L, less than 77 g/L, less than 70 g/L, less than 65 g/L or less than 60 g/L. The polymer may be present in an amount which is between 10 and 200 g/L, between 20 and 175 g/L, between 30 and 150 g/L, between 40 and 125 g/L or between 50 and 100 g/L. In one embodiment, the polymer may be present in an amount which is between 60 and 90 g/L, between 70 and 80 g/L or between 75 and 77 g/L. In an alternative embodiment, the polymer may be present in an amount which is between 40 and 80 g/L, between 45 and 70 g/L, between 50 and 60 g/L or between 52 and 57 g/L. The polymer may be present in an amount which is between 45 and 55 g/L.

An antichaotropic salt may be understood to be a salt which will increase hydrophobic effects within an aqueous solution. Any salt comprising an anion to the left of the Hofmeister series may be considered to be an antichaotropic salt.

Accordingly, the salt may be considered to be an antichaotropic salt if it comprises an anion selected from the left of the Hoffmeister series including, but not limited to, sulphate, phosphate, carbonate, citrate, acetate and fluoride. In some embodiments, the antichaotropic salt is a sulphate or a phosphate. Preferably, the antichaotropic salt is a sulphate.

It may be appreciated that the antichaotropic salt would comprise a cation. The cation may be an alkali metal ion, an alkaline earth metal ion, a transition metal ion or have formula +NR₄, where each R is independently hydrogen, an alkyl, an alkenyl or an alkynyl. The alkyl may be a C₁₋₆ alkyl, the alkenyl may be a C₂₋₆ alkenyl and the alkynyl may be a C₂₋₆ alkynyl. Accordingly, the cation may be a lithium ion, a sodium ion, a potassium ion, a beryllium ion, a magnesium ion, a calcium ion, an ammonium ion or a trimethyl ammonium ion. Accordingly, the antichaotropic salt could be lithium sulphate, sodium sulphate, potassium sulphate, beryllium sulphate, magnesium sulphate, calcium sulphate, ammonium sulphate, trimethyl ammonium sulphate, lithium phosphate, sodium phosphate, potassium phosphate, beryllium phosphate, ammonium phosphate or trimethyl ammonium phosphate. In some embodiments, the antichaotropic salt is ammonium sulphate.

The weight ratio of the polymer to the antichaotropic salt may be at least 0.1:1, at least 0.2:1 or at least 0.3:1. The weight ratio of the polymer to the antichaotropic salt may be at least 0.4:1, at least 0.5:1, at least 0.6:1 or at least 0.7:1, preferably at least 0.8:1, at least 0.85:1, at least 0.9:1, at least 0.95:1 or at least 1:1. The weight ratio of the polymer to the antichaotropic salt may be less than 2:1, less than 1.75:1 or less than 1.5:1, preferably less than 1.4:1, less than 1.3:1, less than 1.2:1, less than 1.1:1 or less than 1.05:1. The weight ratio of the polymer to the antichaotropic salt may be between 0.1:1 and 5:1, between 0.2:1 and 4:1, between 0.3:1 and 3:1, between 0.4:1 and 2:1, between 0.5:1 and 1.75:1 or between 0.6:1 and 1.5:1, preferably between 0.7:1 and 1.4:1, between 0.8:1 and 1.3:1, between 0.9:1 and 1.2:1, between 0.95:1 and 1.1:1 or between 1:1 and 1.05:1. The weight ratio of the polymer to the antichaotropic salt may be between 0.1:1 and 1:1, between 0.2:1 and 0.8:1, between 0.3:1 and 0.6:1 or between 0.4:1 and 0.5:1.

In embodiments where the formulation comprises a solvent, the antichaotropic salt may be present in an amount which is at least 10 g/L, at least 20 g/L, at least 30 g/L, at least 40 g/L, at least 50 g/L, at least 60 g/L, at least 70 g/L or at least 74 g/L. The antichaotropic salt may be present in an amount which is less than 200 g/L, less than 175 g/L, less than 150 g/L, less than 125 g/L, less than 100 g/L, less than 90 g/L, less than 80 g/L or less than 75 g/L. The antichaotropic salt may be present in an amount which is between 10 and 200 g/L, between 20 and 175 g/L, between 30 and 150 g/L or between 40 and 125 g/L. The antichaotropic salt may be present in an amount which is between 50 and 100 g/L, between 60 and 90 g/L, between 70 and 80 g/L or between 74 and 75 g/L. The antichaotropic salt may be present in an amount which is between 60 and 125 g/L, between 80 and 120 g/L, between 100 and 115 g/L or between 110 and 112 g/L.

In embodiments where the formulation comprises a solvent, the antichaotropic salt may be present in an amount which is at least 0.01 M, at least 0.05 M, at least 0.1 M, at least 0.2 M, at least 0.3 M, at least 0.4 M, at least 0.5 M or at least 0.55 M. The antichaotropic salt may be present in an amount which is less than 2 M, less than 1.5 M, less than 1.2 M, less than 1 M, less than 0.8 M, less than 0.7 M, less than 0.6 M or less than 0.57 M. The antichaotropic salt may be present in an amount which is between 0.01 and 2 M, between 0.05 and 1.5 M, between 0.1 and 1.2 M, between 0.2 and 1 M, between 0.3 and 0.8 M, between 0.4 and 0.7 M, between 0.5 and 0.6 M or between 0.55 and 0.57 M.

Advantageously, the inventors have found that the addition of at least one buffer enables them to reduce the amount of antichaotropic salt. This in turn eliminates salting out of the polymer.

In accordance with a second aspect, there is provided a method of producing a formulation for the production of porous polymer particles, the method comprising contacting a polymer, at least one buffer and a salt, wherein the salt is an antichaotropic salt and the buffer is present at a weight ratio of the at least one buffer to the polymer of at least 1:40, and thereby producing the formulation for the production of porous polymer particles.

The method of the second aspect preferably produces the formulation of the first aspect.

Contacting the polymer, the at least one buffer and the antichaotropic salt may comprise:
contacting the polymer, the at least one buffer and a solvent to provide a first mixture;
causing the polymer to dissolve in the solvent to provide a polymer solution; and
contacting the polymer solution with the antichaotropic salt.

The polymer, at least one buffer, antichaotropic salt and solvent may be as defined in relation to the first aspect.

Contacting the polymer, the at least one buffer and the solvent may comprise contacting the polymer with a buffer solution, wherein the buffer solution comprises the solvent and the at least one buffer. The buffer solution may be an aqueous solution. Accordingly, the solvent may be water.

Causing the polymer to dissolve in the solvent to provide a polymer solution may comprise heating the first mixture to an elevated temperature. The elevated temperature may be at least 20° C., at least 30° C., at least 40° C., at least 50° C., at least 60° C., at least 70° C., at least 80° C., at least 90° C., at least 95° C. or at least 97° C. The elevated temperature may be between 20° C. and 500° C., between 30° C. and 400° C., between 40° C. and 300° C., between 50° C. and 200° C., between 60° C. and 175° C., between 70° C. and 150° C., between 80° C. and 125° C., between 90° C. and 110° C., between 95° C. and 100° C. or between 97° C. and 99° C.

The first mixture may be heated at the elevated temperature for at least 5 minutes, at least 10 minutes, at least 15 minutes, at least 20 minutes, at least 25 minutes or at least 30 minutes. The first mixture may be heated at the elevated temperature for between 5 and 300 minutes, between 10 and 120 minutes, between 15 and 60 minutes, between 20 and 45 minutes or between 25 and 30 minutes.

The method may comprise cooling the polymer solution prior to contacting the polymer solution and the antichaotropic salt. The method may comprise cooling the polymer solution to a temperature of less than 95° C., less than 90° C., less than 85° C., less than 80° C., less than 75° C. or less than 71° C. The method may comprise cooling the polymer solution to a temperature between 30 and 95° C., between 40 and 90° C., between 50 and 85° C., between 60 and 80° C., between 65 and 75° C. or between 69 and 71° C.

Contacting the polymer solution with the antichaotropic salt may comprise contacting the polymer solution with a salt solution, wherein the salt solution comprises the antichaotropic salt and a solvent. The salt solution may be an aqueous solution. Accordingly, the solvent may be water. The salt solution may be at a temperature between 30 and 95° C., between 40 and 90° C., between 50 and 85° C., between 60 and 80° C., between 65 and 75° C. or between 69 and 71° C.

The volumetric ratio of the polymer solution to the salt solution may be between 1:1 and 20:1, between 2:1 and 15:1, between 3:1 and 10:1, between 4:1 and 8:1, between 4.5:1 and 7:1, between 5:1 and 6.5:1, between 5.25:1 and 6:1 or between 5.5:1 and 5.7:1.

It may be appreciated that the at least one buffer, the polymer and the antichaotropic salt may be provided at suitable concentrations in the buffer solution, the polymer solution and the salt solution to provide concentrations in the resultant formulation as defined in relation to the first aspect.

In accordance with a third aspect, there is provided use of the formulation of the first aspect to produce porous polymer particles.

In accordance with a fourth aspect, there is provided a method of producing porous polymer particles, the method comprising feeding the formulation of the first aspect into an atomiser to produce porous polymer particles.

The method may comprise conducting the method of the second aspect to produce the formulation prior to feeding the formulation into the atomiser. The method of the second aspect may be completed less than 10 hours prior to conducting the method of the fourth aspect, more preferably less than 8 hours, less than 6 hours, less than 4 hours, less than 2 hours, less than 1 hour or less than 30 minutes prior to conducting the method of the fourth aspect. As explained, the formulation of the first aspect degrades over time. Accordingly, it is advantageous to conduct the method of the fourth aspect as soon as possible after the formulation has been produced.

The formulation may be fed into the atomiser at a temperature of at least 20° C., at least 30° C., at least 40° C., at least 45° C., at least 50° C., at least 55° C. or at least 56° C. The formulation may be fed into the atomiser at a temperature of less than 100° C., less than 90° C., less than 80° C., less than 70° C., less than 65° C., less than 60° C. or less than 57° C. The formulation may be fed into the atomiser at a temperature between 20 and 100° C., between 30 and 90° C., between 40 and 80° C., between 45 and 70° C., between 50 and 65° C. or between 53 and 61° C.

The method may comprise cooling the formulation prior to feeding it into the atomiser. The method may comprise cooling the formulation at a rate of less than or equal to 5° C./min, less than or equal to 2° C./min, less than or equal to 1° C./min, less than or equal to 0.5° C./min, less than or equal to 0.2° C./min or less than or equal to 0.1° C./min. The method may comprise cooling the formulation at a rate of between 0.0001 and 5° C./min, between 0.0005 and 2° C./min, between 0.001 and 1° C./min, between 0.005 and 0.5° C./min, between 0.01 and 0.2° C./min or between 0.05 and 0.1° C./min.

The atomiser may be as described in U.S. Pat. No. 7,207,499 B2.

Feeding the formulation of the first aspect into an atomiser to produce porous polymer particles may comprise:
distributing the formulation onto an atomization wheel;
rotating the atomization wheel to thereby cause a layer of formulation to form due to centrifugal force;
splitting the layer into filaments; and
causing air to flow over the wheel, and thereby causing the filaments to split into the porous polymer particles.

It may be appreciated that the speed of atomization wheel rotation may be selected depending upon the desired size of the porous polymer particles. The skilled person would be able to select a suitable rotation speed. In one embodiment, rotating the atomization wheel may comprise rotating the wheel at a speed of between 1000 and 25000 RPM, between 2000 and 20000 RPM, between 4000 and 15000 RPM between 4500 and 10000 RPM or between 5000 and 8000 RPM.

Preferably, the method comprises causing the polymer particles to travel from the atomization wheel into a catch tray.

In some embodiments, the method comprises producing polymer particles where at least 90%, at least 95% or at least 97% of particles have a diameter between 50 and 200 μm, between 60 and 150 μm or between 76 and 141 μm.

As explained, the formulation of the first aspect degrades over time. Accordingly, the length of the run time may depend upon the specification of the final product. The inventors have been able to obtain high quality porous particles after a run time of between 6 and 7 hours, but it will be appreciated that longer run times could be used for lower specification products. Accordingly, the method may comprise continuously feeding the formulation of the first aspect into an atomiser for at least 30 minutes, at least 1 hour, at least 2 hours, at least 3 hours, at least 4 hours, at least 5 hours or at least 6 hours. The method may comprise continuously feeding the formulation of the first aspect into an atomiser for less than 30 hours, less than 20 hours, less than 15 hours, less than 12 hours, less than 10 hours, less than 8 hours or less than 7 hours. The method may comprise continuously feeding the formulation of the first aspect into an atomiser for between 30 minutes and 30 hours, between 1 hour and 20 hours, between 2 hours and 15 hours, between 3 hours and 12 hours, between 4 hours and 10 hours, between 5 hours and 8 hours or between 6 hours and 7 hours.

The total volume of the formulation may vary depending upon the run time, the desired polymer particle size, the diameter of the atomization wheel and/or the number of atomization wheels being used. The inventors have been able to obtain high quality porous particles with a diameter of about 100 μm using a 20 litre volume of formulation. It may be appreciated that greater volumes could be used for products with a larger bead size or a lower specification. Accordingly, the method may comprise continuously feeding at least 1 litre, at least 2 litres, at least 4 litres, at least 6 litres, at least 8 litres, at least 10 litres, at least 12 litres, at least 14 litres, at least 16 litres, at least 18 litres or at least 20 litres of the formulation of the first aspect into the atomiser. The method may comprise continuously feeding less than 60 litres, less than 50 litres, less than 45 litres, less than 40 litres, less than 35 litres, less than 30 litres, less than 28 litres, less than 26 litres, less than 24 litres, less than 22 litres or less than 21 litres of the formulation of the first aspect into the atomiser. The method may comprise continuously feeding between 1 and 60 litres, between 2 and 50 litres, between 4 and 45 litres, between 6 and 40 litres, between 8 and 35 litres, between 10 and 30 litres, between 12 and 28 litres, between 14 and 26 litres, between 16 and 24 litres, between 18 and 22 litres or between 19 and 20 litres of the formulation of the first aspect into the atomiser.

All features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying drawings, in which:

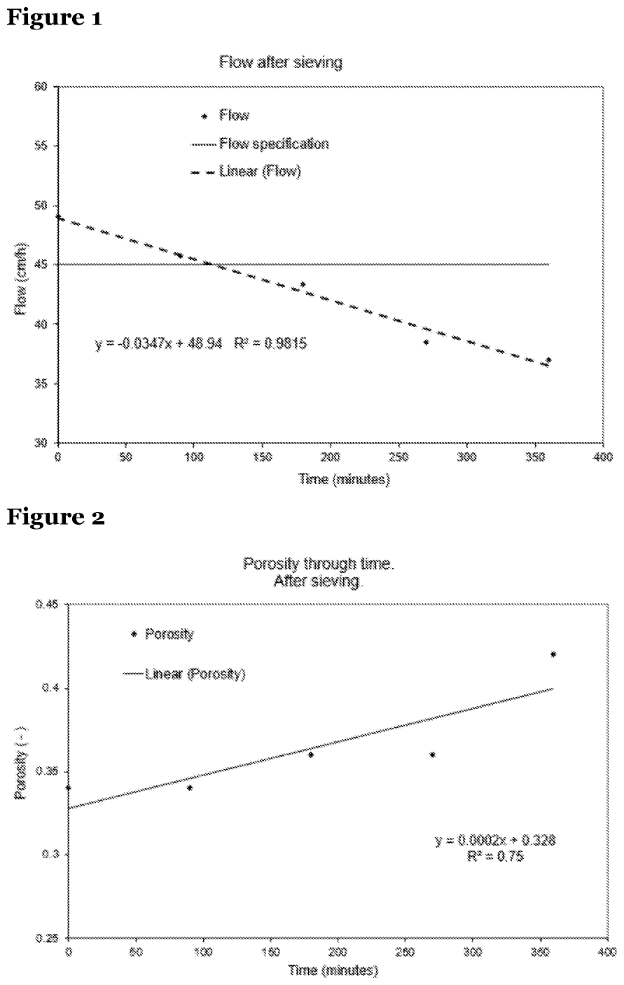

FIG. 1 is a graph showing how the flow rate through an agarose bead composition varied depending at what point in a run the composition was produced; and

FIG. 2 is a graph showing how the porosity of the agarose bead composition varied depending at what point in a run the composition was produced.

### EXAMPLE 1—PRODUCTION OF AGAROSE BEADS USING A FIRST FORMULATION

An agarose bead composition was produced using the formulation provided in table 1.

TABLE 1
Formulation for agarose bead production

| Ingredient | Quantity | |
|---|---|---|
| Agarose | 76 | g/L |
| NaH₂PO₄-H₂O | 1.2 | g/L |
| (NH₄)₂SO₄ | 99.1 | g/L |

| | |
|---|---|
| Purified water | To make up |
| | to 7 litres |

In brief, 85% of the water was combined with the monosodium phosphate. Then the agarose was slowly poured into the water under vigorous mixing. This solution was heated up to 97-99° C. for 30 minutes and cooled down to 70° C. A heating/cooling fluid was used in the jacket of the reactor to control the temperature accurately. Ammonium sulphate solution comprising the remaining water, maintained at 70° C., was added very slowly and under vigorous stirring to the agarose solution. The final solution was cooled to 56-57° C. at a rate not more than 0.1° C./min.

The formulation was then processed to produce a polymer bead composition over a period of 300 minutes.

The flow rate for the beads produced at different times during the procedure was analyzed to determine the flow rate and the porosity. The flow rate was measured using a 1.6 cm diameter column. The results are provided in FIGS. 1 and 2. In particular, as shown in FIG. 1, there was a rapid reduction in the flow rate for the beads produced later in the process. If the compositions produced throughout the run had been combined, the resultant composition would also have been outside of the applicant's specification requirements. FIG. 2 also shows that the porosity of the beads increased during the process.

### EXAMPLE 2—PRODUCTION OF AGAROSE BEADS USING A NOVEL 7 LITRE BATCH FORMULATION

Agarose bead compositions were produced using the novel formulation provided in table 2.

TABLE 2
Novel 7 litre batch formulation for agarose bead production

| Ingredient | Quantity | |
|---|---|---|
| Agarose | 76 | g/L |
| NaH₂PO₄-H₂O | 11.73 | g/L |
| Na₂HPO₄-7H₂O | 0.4 | g/L |
| (NH₄)₂SO₄ | 74.5 | g/L |

| | |
|---|---|
| Purified water | To make up to 7 litres |

The formulation was produced as described above. In particular, the first step of the method comprised combining 85% of the water with the monosodium phosphate and disodium phosphate. The other steps were the same.

It is noted that the new formulation eliminated salting out, a phenomenon which causes clouds of foamy agarose to form on the surface of the preparation solution. This phenomenon was observed when the previous formulation was used. This is advantageous as it prevents trapped air from forming in the formation, which in turn could affect surface area and bead density and reduce porosity.

Three different batches of formulation were processed to produce polymer bead compositions. The resultant compositions were assessed to confirm that they conformed with the specification, as shown in table 3.

TABLE 3
Results of assessment of agarose bead compositions obtained
from the novel 7 litre batch formulation

| | Batch | | |
|---|---|---|---|
| Test | 1 | 2 | 3 |
| Description | White | White | White |
| | suspension of | suspension of | suspension of |
| | microsphere beads | microsphere beads | microsphere beads |
| | with no observable | with no observable | with no observable |
| | particulate | particulate | particulate |
| | contamination | contamination | contamination |
| Particle size | 99.1 % between | 97.9 % between | 98.6 % between |
| analysis | 76 and 141 μm | 76 and 141 μm | 76 and 141 μm |
| Pressure vs. | 50 cm/hr | 49 cm/hr | 53 cm/hr |
| flow test | | | |
| using 1.6 cm | | | |
| diameter | | | |
| column | | | |
| Porosity | 0.34 | 0.31 | 0.31 |
| analysis- | | | |
| Thyroglobulin | | | |
| Microscopy | 0.6% | 0.3% | 1.3% |
| (Mean | | | |
| number of | | | |
| broken, fused | | | |
| and/or | | | |
| damaged | | | |
| beads) | | | |

It will be noted that all of the batches showed an improvement over the batch produced in example 1. In particular, the pressure vs flow test showed a significantly higher rate than would have been obtained if the composition produced throughout the run in example 1 had been combined. It is noted that all of the batches met the applicant's specification requirements.

### EXAMPLE 3—PRODUCTION OF AGAROSE BEADS USING A NOVEL 12 LITRE BATCH FORMULATION

Agarose beads were produced using the novel formulation provided in table 4.

TABLE 4
Novel 12 litre batch formulation for agarose bead production

| Ingredient | Quantity |
|---|---|
| Agarose | 912.00 grams |
| NaH₂PO₄-H₂O | 140.76 grams |
| Na₂HPO₄-7H₂O | 4.84 grams |
| (NH₄)₂SO₄ | 894.00 grams |
| Purified water | To make up to 12 |
| | litres |

The formulation was prepared using the method described above.

Three different batches of formulation were processed to produce polymer bead compositions. The resultant compositions were assessed to confirm that they conformed with the specification, as shown in table 5.

TABLE 5
Results of assessment of agarose bead compositions obtained from the novel
12 litre batch formulation

| | Batch | | |
|---|---|---|---|
| Test | 1 | 2 | 3 |
| Description | White | White | White |
| | suspension of | suspension of | suspension of |
| | microsphere beads | microsphere beads | microsphere beads |
| | with no observable | with no observable | with no observable |
| | particulate | particulate | particulate |
| | contamination | contamination | contamination |
| Particle size | 98.22 % between | 98.26 % between | 98.84 % between |
| analysis | 76 and 141 μm | 76 and 141 μm | 76 and 141 μm |
| Pressure vs. | 103 cm/hr | 102 cm/hr | 106 cm/hr |
| flow test | | | |
| using 3.2 cm | | | |
| diameter | | | |
| column | | | |
| Porosity | 0.30 | 0.31 | 0.29 |
| analysis- | | | |
| Thyroglobulin | | | |
| Microscopy | 1.3% | 0.9% | 1.25% |
| (Mean | | | |
| number of | | | |
| broken, fused | | | |
| and/or | | | |
| damaged | | | |
| beads) | | | |

It will be noted that the pressure vs flow test results changed due to a different diameter column being used. All of the batches met the applicant's specification requirements.

### EXAMPLE 4—PRODUCTION OF AGAROSE BEADS USING A NOVEL 15 LITRE BATCH FORMULATION

Agarose beads were produced using the novel formulation provided in table 6.

TABLE 6
Novel 15 litre batch formulation for agarose bead production

| Ingredient | Quantity |
|---|---|
| Agarose | 1140.00 grams |
| NaH₂PO₄-H₂O | 175.95 grams |
| Na₂HPO₄-7H₂O | 6.05 grams |
| (NH₄)₂SO₄ | 1117.50 to 1387.50 grams |
| Purified water | To make up to 15 litres |

The formulation was prepared using the method described above. The range in the salt concentration is due to variation in the agarose.

Three different batches of formulation were processed to produce polymer bead compositions. The resultant compositions were assessed to confirm that they conformed with the specification, as shown in table 7.

TABLE 7
Results of assessment of agarose bead compositions obtained
from the novel 15 litre batch formulation

| | Batch | | |
|---|---|---|---|
| Test | 1 | 2 | 3 |
| Description | White | White | White |
| | suspension of | suspension of | suspension of |
| | microsphere beads | microsphere beads | microsphere beads |
| | with no observable | with no observable | with no observable |
| | particulate | particulate | particulate |
| | contamination | contamination | contamination |
| Particle size | 93.3 % between | 93.7 % between | 94.7 % between |
| analysis | 76 and 141 μm | 76 and 141 μm | 76 and 141 μm |
| Pressure vs. | 93 cm/hr | 95 cm/hr | 101 cm/hr |
| flow test | | | |
| using 3.2 | | | |
| diameter | | | |
| column | | | |
| Porosity | 0.34 | 0.33 | 0.33 |
| analysis- | | | |
| Thyroglobulin | | | |
| Microscopy | 1.3% | 1.6% | 0.9% |
| (Mean | | | |
| number of | | | |
| broken, fused | | | |
| and/or | | | |
| damaged | | | |
| beads) | | | |

Once again, all of the batches met the applicant's specification requirements.

### EXAMPLE 5—INVESTIGATING THE EFFECT THE BUFFER HAS ON THE POROSITY

It is known that the ammonium sulphate affects the porosity of the resultant composition. However, as indicated above, the inventors were able to reduce the concentration of the ammonium sulphate while still maintaining an acceptable degree of porosity.

The monosodium phosphate and disodium phosphate in the above examples were added as buffers to stabilize the formulation. The inventors decided to test if other buffers could be used and if this would affect the porosity of the resultant composition.

The phosphate buffer described in examples 2 to 4 provides a formulation with a pH of about 5 at 20° C. This was replaced by a 5 mM acetate buffer, which provided a formulation with a pH of 5.0 at 20° C. The acetate formulation was processed to produce a polymer bead composition and the porosity was assessed. The results are provided in table 8.

TABLE 8
Comparing the porosity of an agarose bead composition comprising an acetate
buffer to an exemplary composition comprising a phosphate buffer

| Buffer | Buffer concentration (mM) | K_{AV} Thyroglobulin |
|---|---|---|
| Phosphate | 86.5 | 0.33 |
| Acetate | 5.00 | 0.25 |

The above table shows that the buffer affects the porosity of the composition.

### EXAMPLE 6—FURTHER INVESTIGATING THE EFFECT THE BUFFER HAS ON THE POROSITY

The inventors then investigated the effect of using further alternative buffers, and the results are shown in the table below.

TABLE 9
Comparing the properties of agarose bead compositions
comprising various buffers

| | | K_{AV} | Pressure drop v | Diameter |
|---|---|---|---|---|
| pH | Buffer | Thyroglobulin | flow (cm/h) | (um) |
| 5.0 | Acetate | 0.25 | 95.52 | 105.47 |
| 6.0 | MES | 0.24 | 90.3 | 103.91 |
| 7.0 | BIS-TRIS | 0.18 | 85.58 | 104.67 |
| 8.3 | TBE | 0.16 | 94.03 | 103.06 |
| 5.0 | Phosphate | 0.35 | 75.42 | 109.2 |

It will be noted that the pH does not appear to have an effect on the properties of the compositions. However, phosphate buffer significantly increased the porosity of the composition compared to the other buffers.

### EXAMPLE 7—INVESTIGATING THE EFFECT THE CHOICE OF SALT HAS ON THE POROSITY

The inventors decided to investigate the effect the choice of salt has on the porosity of the resultant composition.

First the inventors investigate the effect that the sulphate group had by preparing polymer beads using formulations comprising either ammonium sulphate or ammonium chloride. The concentration of ammonium was kept constant for the two formulations, and the results are shown in table 10.

TABLE 10
Showing the porosity of the resultant composition produced
from one formulation comprising ammonium sulphate and
one comprising ammonium chloride

| [(NH₄)₂SO₄] (M) | [(NH₄)Cl] (M) | K_{AV} Thyroglobulin |
|---|---|---|
| 0.5638 | — | 0.33 |
| — | 1.1276 | 0.02 |

The inventors then looked at whether replacing the ammonium group had an effect.

TABLE 11
Showing the porosity of the resultant composition produced from one
formulation comprising sodium sulphate and one comprising sodium chloride

| [Na₂SO₄] (M) | [NaCl] (M) | K_{AV} Thyroglobulin |
|---|---|---|
| 0.30 | — | 0.21 |
| — | 0.60 | 0.02 |

Table 10 shows that when ammonium sulphate is replaced with ammonium chloride the porosity significantly decreases. Meanwhile, table 11 shows that sodium chloride produces almost no porosity, which is in line with the result observed for ammonium chloride. Sodium sulphate produces a porosity about two thirds that observed for ammonium sulphate, but the difference could be due to the difference in concentrations as opposed to the replacement of the ammonium ion. Therefore, the table shows that it is possible to induce a porosity when the ammonium ion is replaced. Accordingly, it appears that the selection of the anion is of more importance for inducing a porosity.

### EXAMPLE 8—TESTING FURTHER COMPOSITIONS

The inventors then made further formulations as described in the Table below.

TABLE 12
Further formulations for agarose bead production

| | Formulation | | | | | |
|---|---|---|---|---|---|---|
| Ingredient | A | | B | | C | |
| Agarose | 50 | g/L | 50 | g/L | 50 | g/L |
| NaH₂PO₄ | 11.73 | g/L | 7.72 | g/L | 11.73 | g/L |
| Na₂HPO₄ | 0.4 | g/L | 0.265 | g/L | 0.4 | g/L |
| (NH₄)₂SO₄ | 116.7 | g/L | 116.7 | g/L | 92.5 | g/L |

| | | | |
|---|---|---|---|
| Purified water | To make up to 12 | To make up to 12 | To make up to 12 |
| | litres | litres | litres |

The formulations were produced using the methods described above. A batch of formulation A was used to produce polymer bead compositions with a desired diameter of 100 μm, batches of formulation B were used to produce polymer bead compositions with a desired diameter of 60 μm and 100 μm, and a batch of formulation C was used to produce polymer bead compositions with a desired diameter of 200 μm. The resultant compositions were assessed to confirm that they conformed with the specification, as shown in table 13.

| Formulation | A | B | C |
|---|---|---|---|
| Diameter | 106 μm | 99 μm | 212.8 μm |
| (um) | | | |
| Particle size | 96.8 % between | 96.9 % between | not tested |
| analysis | 76 and 141 μm | 76 and 141 μm | |
| Pressure vs. | 39 cm/hr | 34 cm/hr | not tested |
| flow test using | | | |
| 3.2 cm | | | |
| diameter | | | |
| column | | | |
| Porosity | 0.58 K_{AV} | 0.56 K_{AV} | not tested |
| analysis- | | | |
| Thyroglobulin | | | |
| Microscopy | 0.30% | 0.30% | not tested |
| (mean | | | |
| number of | | | |
| broken, fused | | | |
| and/or | | | |
| damaged | | | |
| beads) | | | |

It is noted that due to the lower agarose concentration and the high salt concentration, these composition had a high porosity and a low flow rate. Accordingly, the formulation can be varied to tweak the properties of the resultant composition, as desired.

### METHODS

All of the polymer bead compositions described in the examples were produced using the apparatus and methods described in U.S. Pat. No. 7,207,499 B2, which is incorporated by reference.

### Pressure vs Flow Analysis

Pressure vs flow for agarose beads produced from the formulations described in the examples was measured in 2 different ways, either by maintaining a constant flow through a column of beads and measuring the pressure, or by maintaining a constant pressure and measuring the flow.

### Method 1 (Constant Flow)

This method was used for the pressure vs flow analysis reported in example 2.

The agarose beads were washed using purified water a total of 4 times, a final aliquot of water was added, and allowed to drain under gravity. 66 g of the settled beads were weighed, made to 80 g with purified water, and then degassed for 10 minutes.

The suspension was transferred into a column with a diameter of 1.6 cm and allowed to equilibrate at a flow rate of 1.0 mL/min for 90 minutes. After equilibration a bed height in the range 30±1 cm was expected. The pressure was measured over a period of 10 minutes at a flow of 0.8 mL/min, if the pressure was stable over the 10 minute period the flow rate was increased by 0.2 mL/min and the pressure measurement repeated. Additional increases in the flow and further pressure measurements were continued until the pressure stopped being stable over the 10 minute period. If it was not possible to get a stable pressure at 0.8 mL/min the flow was reduced to 0.7 m/min and the pressure measurement repeated.

For each set of measurements the linear flow rate was calculated using the formula below:

$$Linear Flow rate ( cm / hr ) = \frac{Measured Flow ( mL / min ) \times 60 ( min / hr )}{2.01}$$

Where 2.01 was the cross sectional area of the column in cm².

The maximum linear flow rate obtained was recorded.

### Method 2 (Constant Pressure)

This method was used for the pressure vs flow analysis reported in examples 3 and 4.

The agarose beads were washed using purified water a total of 4 times, a final aliquot of water was added, and allowed to drain under gravity. 142 g of the settled beads were weighed, made to 180 g with purified water, and then degassed for 15 minutes.

The suspension was transferred into a column with a diameter of 3.2 cm and allowed to equilibrate at a pressure of 10 psi for 20 minutes. After equilibration a bed height in the range 15±1 cm was expected. The pressure was adjusted to 2.5 psi and allowed to stabilize for 5 minutes, the eluent from the column was the collected over the subsequent 5 minutes and the volume measured. Analysis was repeated at pressures of 5.0, 7.5, 10.0, 12.5, and 15.0 psi. The actual flow rate for each pressure was calculated using the formula below

$$Actual flow rate ( mL / min ) = \frac{Volume Collected ( mL )}{5}$$

Where 5 was the number of minutes the volume was collected over.

For each pressure level the linear flow rate was calculated using the formula below:

$$Linear Flow rate ( cm / hr ) = \frac{Actual Flow ( mL / min ) \times 60 ( min / hr )}{8.04}$$

Where 8.04 was the cross sectional area of the column in cm².

The maximum linear flow rate obtained was noted as well as the corresponding bed height and pressure.

The result for the maximum linear flow was normalized to a 15 cm bed height using the following formula:

$$Normalised Flow rate = Linear Flow Rate ( cm / hr ) \times F$$

Where F was the measured height of the gel bed divided by 15 and is expected to be in the range of 0.933 to 1.067.

### Bead Size Analysis

Bead size was measured using a Bench Top FlowCam using the standard procedure for the device.

### Porosity Analysis

Porosity was measured using the Waters HPLC system (solvent selector, pump 1515, autosampler 717 plus, column selector and UV-VIS detector 2487). A Waters AP-2 2.0 cm (I.D.)×20.0 cm (L) glass column graduated with adapters (piston and column bottoms) and filling funnel was filled with TRIS/HCl buffer (50 mM) KCl (100 mM) solution at pH 7.5 and degassed agarose beads produced from the formulations described in the examples. The column was allowed to pack for 60 minutes. The height of the compacted gel bed was confirmed to be at least 16 cm and the HPLC system was equilibrated under analysis conditions (flow rate at 0.70 ml/min, detector wavelength at 280 nm and autosampler temperature at 4° C. The system was allowed to equilibrate for 45 minutes or until a stable baseline integration line was obtained.

A solution of Blue Dextran (2 mg/ml) and a further solution of thyroglobulin (8 mg/ml) were made up in a buffer (TRIS/HCl (50 mM) KCl (100 mM) pH=7.50).

The height of the gel bed was noted and 250 μL of the Blue Dextran solution injected. The porosity (KAV) relative to Dextran Blue was calculated as follows:

$$\frac{\begin{matrix}[ {Tr}_{thyroglobulin )} min ] \times ( ml / min ) ] - \\ [ {Tr}_{( Dextran Blue )} \times Flow ( ml / min ) ]\end{matrix}}{\begin{matrix}[ π {cm}^{2} \times height of gel bed ( cm ) ] - \\ [ {Tr}_{( Blue Dextran )} \times Flow ( ml / min ) ]\end{matrix}} = {K}_{AV}$$

Where:
Tr_{(thyroglobulin)} is the retention time of the thyroglobulin;
Tr_{(Dextran Blue)} is the retention time of the Dextran Blue; and
π cm² is the cross sectional area of the column.

What is claimed is:

1. A formulation for the production of porous polymer particles, the formulation comprising a polymer; a salt; and at least one buffer; wherein the salt is an antichaotropic salt and the at least one buffer is present at a weight ratio of the at least one buffer to the polymer of at least 1:40.

2. The formulation according to claim 1, wherein the formulation comprises a solvent, and the solvent is water.

3. The formulation according to claim 2, wherein the polymer is present in an amount which is between 10 and 200 g/L, between 20 and 175 g/L, between 30 and 150 g/L, between 40 and 125 g/L or between 50 and 100 g/L.

4. The formulation according to claim 2, wherein the antichaotropic salt is present in an amount between 0.01 and 2 M, between 0.05 and 1.5 M, between 0.1 and 1.2 M, between 0.2 and 1 M, between 0.3 and 0.8 M, between 0.4 and 0.7 M, between 0.5 and 0.6 M or between 0.55 and 0.57 M.

5. The formulation according to claim 1, wherein the at least one buffer comprises or is a phosphate buffer, a sulphate buffer, a citrate buffer, an acetate buffer, a tris(hydroxymethyl)aminomethane (tris) buffer and/or a 2-(N-morpholino)ethanesulfonic acid (MES) buffer.

6. The formulation according to claim 5, wherein the at least one buffer comprises or is a phosphate buffer.

7. The formulation according to claim 6, wherein the at least one buffer comprises or is a combination of a dihydrogen phosphate buffer and a hydrogen phosphate buffer.

8. The formulation according to claim 1, wherein the weight ratio of the at least one buffer to the polymer is between 1:2 and 1:40, between 1:3 and 1:30, between 1:4 and 1:20, between 1:5 and 1:15, between 1:6 and 1:10, between 1:6.5 and 1:8 or between 1:7 and 1:7.5.

9. The formulation according to claim 1, wherein has a pH between 2.5 and 12, between 3 and 10, between 3.5 and 8, between 4 and 6 or between 4.5 and 5.5 at 20° C.

10. The formulation according to claim 1, wherein the polymer is a polysaccharide, and the polysaccharide is agarose.

11. The formulation according to claim 1, wherein the antichaotropic salt is a salt comprising an anion selected from the group consisting of sulphate, phosphate, carbonate, citrate and fluoride.

12. The formulation according to claim 11, wherein the antichaotropic salt is a sulphate.

13. The formulation according to claim 1, wherein the weight ratio of the polymer to the antichaotropic salt is between 0.5:1 and 2:1, between 0.6:1 and 1.75:1 or between 0.7:1 and 1.5:1, preferably between 0.8:1 and 1.4:1, between 0.85:1 and 1.3:1, between 0.9:1 and 1.2:1, between 0.95:1 and 1.1:1 or between 1:1 and 1.05:1.

14. A method of producing a formulation for the production of porous polymer particles, the method comprising contacting a polymer, a at least one buffer and a salt, wherein the salt is an antichaotropic salt and the at least one buffer is present at a weight ratio of the at least one buffer to the polymer of at least 1:40, and thereby producing the formulation for the production of porous polymer particles.

15. The method according to claim 14, wherein contacting the polymer, the at least one buffer and the salt comprises:
contacting the polymer, the at least one buffer and a solvent to provide a first mixture;
causing the polymer to dissolve in the solvent to provide a polymer solution; and
contacting the polymer solution with the antichaotropic salt.

16. The method according to claim 15, wherein causing the polymer to dissolve in the solvent to provide a polymer solution comprises heating the first mixture to an elevated temperature, wherein the elevated temperature is between 20° C. and 500° C., between 30° C. and 400° C., between 40° C. and 300° C., between 50° C. and 200° C., between 60° C. and 175° C., between 70° C. and 150° C., between 80° C. and 125° C., between 90° C. and 110° C., between 95° C. and 100° C. or between 97° C. and 99° C.

17. The method according to claim 16, wherein the method comprises cooling the first solution prior to contacting the first solution and the salt, wherein the first solution is cooled to a temperature of between 30 and 95° C., between 40 and 90° C., between 50 and 85° C., between 60 and 80° C., between 65 and 75° C. or between 69 and 71° C.

18. (canceled)

19. A method of producing porous polymer particles, the method comprising feeding the formulation defined by claim 1 into an atomiser to produce porous polymer particles.

20. The method according to claim 19, wherein the method comprises conducting the method defined by claim 14 to produce the formulation prior to feeding the formulation into the atomiser.

21. The method according to claim 19, wherein the method comprises continuously feeding the formulation into an atomiser for at least 30 minutes, at least 1 hour, at least 2 hours, at least 3 hours, at least 4 hours, at least 5 hours or at least 6 hours and/or wherein the method comprises continuously feeding at least 1 litre, at least 2 litres, at least 4 litres, at least 6 litres, at least 8 litres, at least 10 litres, at least 12 litres, at least 14 litres, at least 16 litres, at least 18 litres or at least 20 litres of the formulation into the atomiser.

22. (canceled)
